(19) United States
(12) Patent Application Publication
(10) Pub. No.: US 2026/0257476 A1
(43) Pub. Date: Sep. 3, 2026

(54) LIQUID EJECTING HEAD AND LIQUID EJECTING APPARATUS

(71) Applicant: SEIKO EPSON CORPORATION, Tokyo (JP)

(72) Inventors: Takahiro KANEGAE, SHIOJIRI-SHI (JP); Yoichi NAGANUMA, MATSUMOTO-SHI (JP); Satoko UEKAWA, SHIOJIRI-SHI (JP); Yu SHIOZAWA, MINAMIMINOWA-MURA (JP)

(21) Appl. No.: 19/549,199

(22) Filed: Feb. 25, 2026

(30) Foreign Application Priority Data
Feb. 28, 2025 (JP) 2025-032464

(51) Int. Cl. B41J 2/14

(52) U.S. Cl. CPC B41J 2/14233; B41J 2002/14306; B41J 2002/14419

(57) ABSTRACT

A flow path member having a plurality of nozzles, a plurality of individual flow paths, and a common flow path includes a pressure chamber substrate that is provided with a pressure chamber, and a communication plate in which some of the individual flow paths are provided, the pressure chamber substrate is stacked on a second surface that is a surface in a second direction of the communication plate, a case member is disposed on the second surface via a gap in a third direction of the pressure chamber substrate, the communication plate has a plurality of first recessed portions which are recessed to a first bottom surface, and some of which overlap a gap when viewed in a first direction, and a space defined by the first recessed portion is a portion of the individual flow path.

The present application is based on, and claims priority from JP Application Serial Number 2025-032464, filed Feb. 28, 2025, the disclosure of which is hereby incorporated by reference herein in its entirety.

### BACKGROUND

### 1. Technical Field

The present disclosure relates to a liquid ejecting head that ejects a liquid from a nozzle, and a liquid ejecting apparatus.

### 2. Related Art

JP-A-2024-14040 discloses a liquid ejecting head in which a flow path forming substrate 26 and a pressure chamber substrate 23 are stacked on one surface of a communication plate 22. The communication plate 22 is provided with a portion of an individual flow path RK that individually communicates with a nozzle N, and a portion of each of common flow paths R1 and R2 that commonly communicate with a plurality of the individual flow paths RK. The flow path forming substrate 26 and the pressure chamber substrate 23 are stacked in a direction opposite to a Z1 direction of the communication plate 22, and there is a gap between the flow path forming substrate 26 and the pressure chamber substrate 23. Therefore, flow paths BA1 and BA2 overlapping the gap when viewed in the Z1 direction, among flow paths that are provided in the communication plate 22, are defined by recessed portions recessed in the direction opposite to the Z1 direction from the surface in the Z1 direction of the communication plate 22. In other words, the communication plate 22 has a wall portion that blocks the gap, and the common flow paths BA1 and BA2 that are provided in the communication plate 22 are defined by the wall portion.

It is desired to discharge a liquid at a high speed without reducing the discharge amount of the liquid, and thus it is effective to shorten a flow path length from a pressure chamber to the nozzle. In order to shorten the flow path length, it is necessary to reduce the thickness of the communication plate. However, when the communication plate is made thin, the wall portion also needs to be made thin, and thus the rigidity of the wall portion is lowered. Therefore, when an external force such as a collision with a medium is applied to an ejection surface of the head, there is a concern that the communication plate may be deformed and cracked.

### SUMMARY

According to an aspect of the present disclosure, there is provided a liquid ejecting head including: a flow path member having a plurality of nozzles that eject a liquid in a first direction, a plurality of individual flow paths that individually communicate with the plurality of nozzles, and a common flow path that commonly communicates with the plurality of individual flow paths, in which the flow path member includes a pressure chamber substrate that is provided with a pressure chamber which is a portion of the individual flow path and in which pressure is applied to the liquid to eject the liquid, and a communication plate that is provided with a flow path which is a portion of the individual flow path and causes the nozzle and the pressure chamber to communicate with each other, and that has a second surface which is a surface in a second direction that is a direction opposite to the first direction, the pressure chamber substrate is stacked on the second surface, a flow path section located in the second direction with respect to the second surface is disposed with a gap in a third direction which is a direction orthogonal to the first direction and the second direction of the pressure chamber substrate, the communication plate has a plurality of first recessed portions which are recessed from a first surface that is a surface in the first direction of the communication plate to a bottom surface located between the first surface and the second surface, and some of which overlap the gap when viewed in the first direction, and a space defined by the first recessed portion is a portion of the individual flow path.

According to another aspect of the present disclosure, there is provided a liquid ejecting apparatus including: the liquid ejecting head according to the above aspect; and a liquid storage section that supplies a liquid to the liquid ejecting head.

### BRIEF DESCRIPTION OF THE DRAWINGS

FIG. 1 is a schematic configuration diagram of a liquid ejecting apparatus.

FIG. 2 is an exploded perspective view of a liquid ejecting head unit.

FIG. 3 is a sectional view of a main portion of the liquid ejecting head unit taken along line III-III in FIG. 2.

FIG. 4 is an exploded perspective view of a liquid ejecting head.

FIG. 5 is a top view of a communication plate when viewed in a +Z direction.

FIG. 6 is a bottom view of the communication plate when viewed in a −Z direction.

FIG. 7 is a sectional view of the liquid ejecting head taken along line VII-VII in FIG. 6.

FIG. 8 is a sectional view of the liquid ejecting head taken along line VIII-VIII in FIG. 6.

FIG. 9 is a sectional view illustrating a modification example of the liquid ejecting head taken along line IX-IX in FIG. 6.

### DESCRIPTION OF EMBODIMENTS

The present disclosure will be described in detail below based on an embodiment. However, the following description shows one aspect of the present disclosure, and can be modified as desired within the scope of the present disclosure. In each drawing, the same reference numerals indicate the same members, and the description thereof will be omitted as appropriate. In addition, in each drawing, X, Y, and Z represent three spatial axes that are orthogonal to each other. In the present specification, directions along these axes will be referred to as an X direction, a Y direction, and a Z direction. In each drawing, a direction indicated by an arrow is a positive (+) direction, and a direction opposite to the arrow is a negative (−) direction. The Z direction indicates a vertical direction, the +Z direction indicates a vertically downward direction, and the −Z direction indicates a vertically upward direction. Furthermore, directions along the three spatial axes when the positive direction and negative direction thereof are not limited will be referred to as an X-axis direction, a Y-axis direction, and a Z-axis direction.

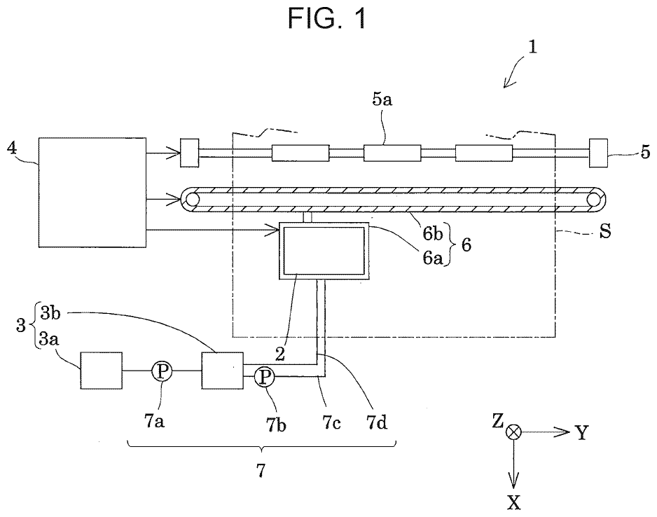

FIG. 1 is a diagram illustrating a schematic configuration of a liquid ejecting apparatus 1 according to the present disclosure. As illustrated in the drawing, the liquid ejecting apparatus 1 is an ink jet recording apparatus that causes ink, which is one type of liquid, to be ejected and land on a medium S such as a printing paper sheet as ink droplets, and that prints an image or the like based on an arrangement of dots formed on the medium S. As the medium S, any material, such as a resin film or cloth, can be used instead of recording paper.

The liquid ejecting apparatus 1 includes a liquid ejecting head unit 2, a liquid storage section 3, a control section 4, a transport mechanism 5, and a moving mechanism 6. The liquid ejecting head unit 2 ejects the ink, which is supplied from the liquid storage section 3, from a plurality of nozzles to the medium S. A detailed configuration of the liquid ejecting head unit 2 will be described later.

The liquid storage section 3 stores the ink that is to be ejected from the liquid ejecting head unit 2. As the liquid storage section 3, a cartridge that is attachable to and detachable from the liquid ejecting apparatus 1, a bag-shaped ink pack made of a flexible film, an ink tank that can be replenished with ink, or the like can be given as an example. Although not particularly illustrated in the drawing, for example, a plurality of types of ink having different colors, components, or the like are individually stored in the liquid storage section 3.

In the present embodiment, the liquid storage section 3 includes a main tank 3a and a sub-tank 3b for each type of ink. The sub-tank 3b is coupled to the liquid ejecting head unit 2. When the ink droplets are ejected in the liquid ejecting head unit 2, the same amount of ink as the amount consumed by the ejection is replenished from the main tank 3a to the sub-tank 3b. Of course, the liquid storage section 3 may be made of only the main tank 3a.

The liquid ejecting apparatus 1 includes a circulation mechanism 7 for circulating ink between the liquid ejecting head unit 2 and the sub-tank 3b. The circulation mechanism 7 includes a supply pump 7a, a circulation pump 7b, the sub-tank 3b, a supply tube 7c, and a recovery tube 7d.

The supply pump 7a is a pump that supplies the ink stored in the main tank 3a to the sub-tank 3b. The circulation pump 7b is a pump for supplying, that is, pressure-feeding the ink stored in the sub-tank 3b to the liquid ejecting head unit 2. The supply tube 7c is provided with a flow path for the ink that is supplied from the sub-tank 3b to the liquid ejecting head unit 2. The recovery tube 7d is provided with a flow path for the ink that is not used for printing in the liquid ejecting head unit 2 and is recovered to the sub-tank 3b. The sub-tank 3b is a container that temporarily stores ink. In addition, the sub-tank 3b temporarily stores the ink that is not used for printing in the liquid ejecting head unit 2 and is recovered via the recovery tube 7d.

The circulation mechanism 7 as described above supplies ink from the sub-tank 3b to the liquid ejecting head unit 2 via the supply tube 7c by the circulation pump 7b, and recovers the ink not used in the liquid ejecting head unit 2 to the sub-tank 3b via the recovery tube 7d. In this way, the ink circulates between the liquid ejecting head unit 2 and the sub-tank 3b. Further, when the amount of ink stored in the sub-tank 3b is equal to or less than a certain amount, ink is supplied from the main tank 3a to the sub-tank 3b by the supply pump 7a.

The control section 4 includes, for example, a control device such as a central processing unit (CPU) or a field programmable gate array (FPGA), and a storage device such as a semiconductor memory. In addition, the control section 4 includes a power supply device that supplies electric power that is supplied from an external power source such as a commercial power source to each element of the liquid ejecting apparatus 1. The control section 4 is electrically coupled to the liquid ejecting head unit 2 via an external wire (not shown). The control section 4 comprehensively controls each element of the liquid ejecting apparatus 1 by the control device executing a program stored in the storage device.

The transport mechanism 5 is for transporting the medium S in the X-axis direction, and has, for example, a transport roller 5a that is rotated by a transport motor that is driven under the control of the control section 4.

The moving mechanism 6 is a mechanism for reciprocating the liquid ejecting head unit 2 in the Y-axis direction, and includes a holding body 6a that holds the liquid ejecting head unit 2, and a transport belt 6b that is an endless belt installed along the Y-axis direction. The control section 4 rotates the transport belt 6b by controlling the drive of a transport motor (not illustrated) to reciprocate the liquid ejecting head unit 2 in the Y-axis direction together with the holding body 6a fixed to the transport belt 6b.

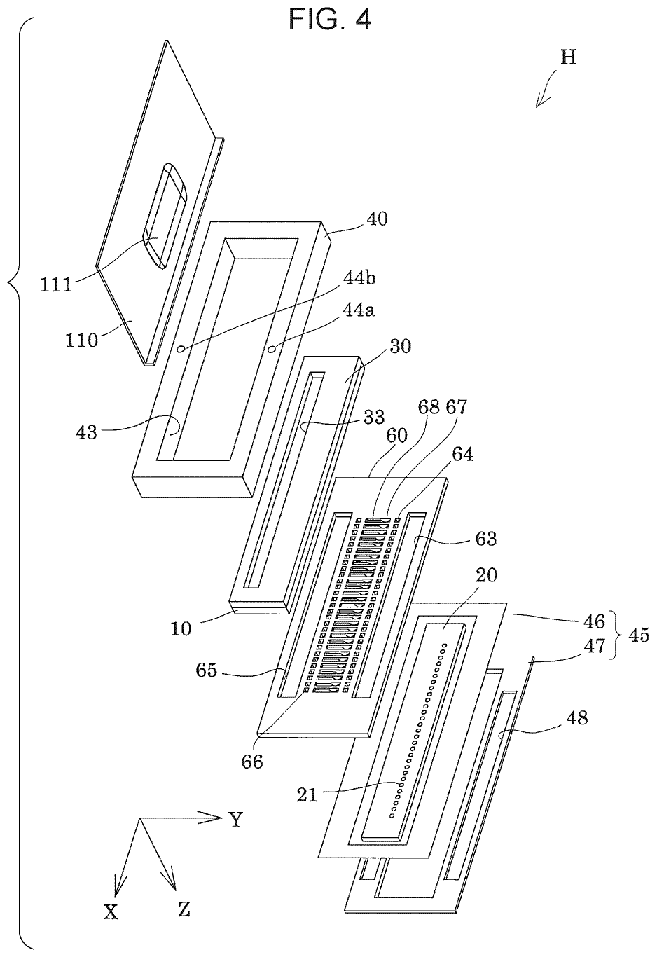

Under the control of the control section 4, the liquid ejecting head unit 2 executes an ejection operation of ejecting the ink supplied from the liquid storage section 3 in the +Z direction as ink droplets from each of a plurality of nozzles 21 (refer to FIG. 4 and the like). The ejection operation by the liquid ejecting head unit 2 is performed in parallel with the transport of the medium S by the transport mechanism 5 or the reciprocating movement of the liquid ejecting head unit 2 by the moving mechanism 6, so that the ink is applied to the medium S, that is, so-called printing is performed.

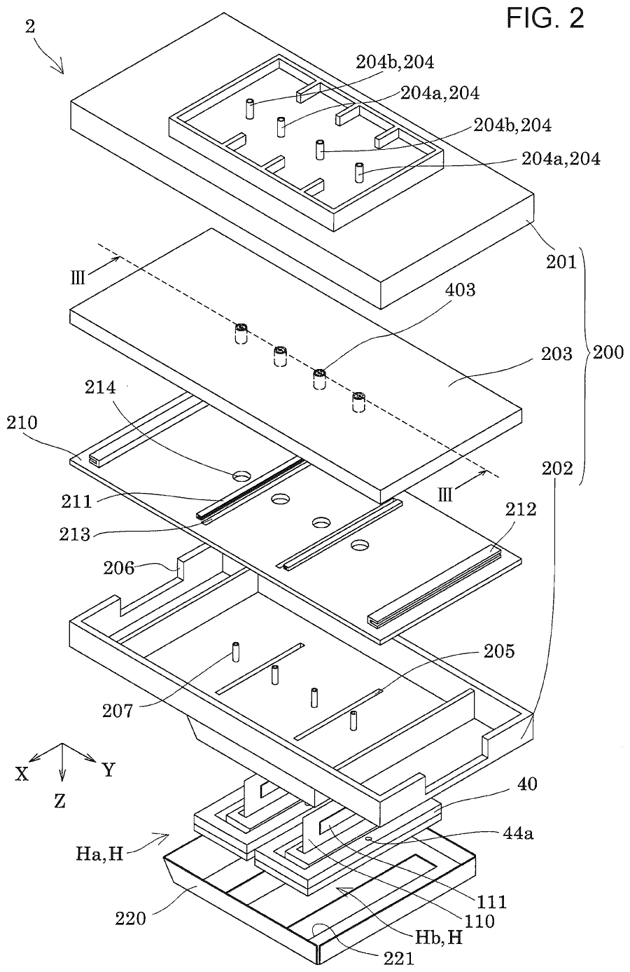

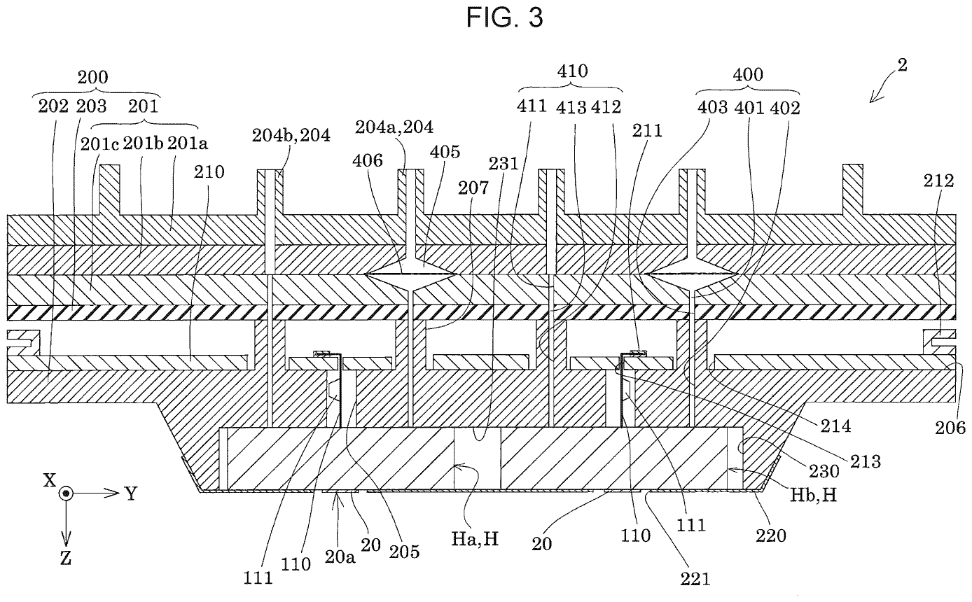

FIG. 2 is an exploded perspective view of the liquid ejecting head unit 2. FIG. 3 is a sectional view of a main portion of the liquid ejecting head unit 2 taken along line III-III in FIG. 2. Each direction of the liquid ejecting head unit 2 will be described based on the directions when the liquid ejecting head unit 2 is mounted on the liquid ejecting apparatus 1, that is, the X-axis direction, the Y-axis direction, and the Z-axis direction.

As illustrated in the drawings, the liquid ejecting head unit 2 includes a plurality of liquid ejecting heads H, a flow path structure body 200 having a supply flow path 400 and a recovery flow path 410, a relay substrate 210, and a cover 220.

The flow path structure body 200 includes the supply flow path 400 for supplying the ink supplied from the sub-tank 3b to the liquid ejecting head H, and the recovery flow path 410 for recovering the ink not used in the liquid ejecting head H to the sub-tank 3b.

The flow path structure body 200 includes a first flow path structure section 201, a second flow path structure section 202, and a seal member 203. The first flow path structure section 201, the seal member 203, and the second flow path structure section 202 are stacked in this order in the +Z direction.

The first flow path structure section 201 is a member provided with a first supply flow path 401 and a first recovery flow path 411, and in the present embodiment, the first flow path structure section 201 has a configuration in which three members such as a first member 201a, a second member 201b, and a third member 201c are stacked in the Z-axis direction. The first flow path structure section 201 has a supply tube connection portion 204a and a recovery tube connection portion 204b on a surface facing the −Z direction. When the supply tube connection portion 204a and the recovery tube connection portion 204b are not distinguished, the supply tube connection portion 204a and the recovery tube connection portion 204b are referred to as a tube connection portion 204. In the present embodiment, the tube connection portion 204 has a shape protruding in a tubular shape in the −Z direction on the surface in the −Z direction of the first flow path structure section 201. The supply tube 7c is coupled to the supply tube connection portion 204a, and the recovery tube 7d is coupled to the recovery tube connection portion 204b. The first supply flow path 401 is provided inside the supply tube connection portion 204a, and the first recovery flow path 411 is provided inside the recovery tube connection portion 204b.

The first supply flow path 401 and the first recovery flow path 411 are configured to include a flow path extending in the Z-axis direction, a flow path extending along a stacked interface between the stacked members, and the like. In addition, a liquid reservoir portion 405 having a wider inner diameter than other regions is provided in the middle of the first supply flow path 401, and a filter 406 that captures foreign matter such as dust or air bubbles contained in the ink is provided in the liquid reservoir portion 405. In the present embodiment, the first flow path structure section 201 includes two supply tube connection portions 204a, two recovery tube connection portions 204b, two independent first supply flow paths 401, and two independent first recovery flow paths 411. The first supply flow path 401 may be branched into two or more, for example, downstream of the filter 406.

The second flow path structure section 202 has a second supply flow path 402 communicating with each of the first supply flow paths 401, and a second recovery flow path 412 communicating with each of the first recovery flow paths 411. That is, the second flow path structure section 202 has two second supply flow paths 402 and two second recovery flow paths 412. The first supply flow path 401 and the second supply flow path 402 are liquid-tightly coupled to each other via the seal member 203. Similarly, the first recovery flow path 411 and the second recovery flow path 412 are liquid-tightly coupled to each other via the seal member 203. For the seal member 203, a material which has liquid resistance to a liquid such as ink that is used in the liquid ejecting head unit 2, and which is elastically deformable, for example, rubber, elastomer, or the like can be used. The seal member 203 is provided with a third supply flow path 403 and a third recovery flow path 413 penetrating in the Z-axis direction, the first supply flow path 401 and the second supply flow path 402 communicate with each other via the third supply flow path 403, and the first recovery flow path 411 and the second recovery flow path 412 communicate with each other via the third recovery flow path 413. That is, the flow path structure body 200 includes two supply flow paths 400, and each of the supply flow paths 400 includes the first supply flow path 401, the second supply flow path 402, and the third supply flow path 403. Further, the flow path structure body 200 includes two recovery flow paths 410, and each of the recovery flow paths 410 includes the first recovery flow path 411, the second recovery flow path 412, and the third recovery flow path 413.

The second flow path structure section 202 has an accommodation portion 230 having a recess shape that is open on a surface facing the +Z direction. The liquid ejecting head H is accommodated in the accommodation portion 230. In the present embodiment, the liquid ejecting head unit 2 includes a plurality of the liquid ejecting heads H, for example, two liquid ejecting heads H. The liquid ejecting head disposed in the −Y direction, out of the two liquid ejecting heads H, is also referred to as a liquid ejecting head Ha, and the liquid ejecting head disposed in the +Y direction is also referred to as a liquid ejecting head Hb. The two liquid ejecting heads H are held in one common accommodation portion 230. The number of liquid ejecting heads H held in the liquid ejecting head unit 2 is not particularly limited thereto, and may be one or a plurality of two or more. Further, the accommodation portion 230 may be provided independently for each liquid ejecting head H, or may be provided for each liquid ejecting head group composed of two or more liquid ejecting heads H.

In the present embodiment, the two liquid ejecting heads H are arranged side by side in the Y-axis direction to be at the same position in the X-axis direction. The surface of the liquid ejecting head H facing the −Z direction and the bottom surface of the accommodation portion 230, that is, the surface facing the +Z direction are bonded to each other by an adhesive (not illustrated). The disposition of the plurality of liquid ejecting heads H is not particularly limited thereto.

The second supply flow path 402 and the second recovery flow path 412 are open on the bottom surface of the accommodation portion 230 of the second flow path structure section 202. An introduction port 44a of the liquid ejecting head H and the second supply flow path 402 communicate with each other, and an outlet 44b of the liquid ejecting head H and the second recovery flow path 412 communicate with each other. In the present embodiment, one second supply flow path 402 is provided for one liquid ejecting head H. One second recovery flow path 412 is provided for one liquid ejecting head H.

The second flow path structure section 202 has a first wire insertion hole 205 penetrating in the Z-axis direction. The first wire insertion hole 205 is provided such that one end thereof is open on the surface of the second flow path structure section 202 facing the −Z direction and the other end thereof is open on a flow path connection surface 231. A wire member 110 of the liquid ejecting head H, which will be described in detail later, is led out toward the surface of the second flow path structure section 202 facing the −Z direction through the first wire insertion hole 205. In the present embodiment, two first wire insertion holes 205 are provided corresponding to each of the two liquid ejecting heads H.

The relay substrate 210 to which the wire members 110 of the plurality of liquid ejecting heads H are commonly coupled is provided between the seal member 203 and the second flow path structure section 202 in the Z-axis direction. The relay substrate 210 is made of a hard rigid substrate having no flexibility, and a wire, electronic components, and the like (not illustrated) are mounted thereon. In the present embodiment, as an example of the electronic component, a connector 211 to which the wire member 110 of the liquid ejecting head H is coupled, and an external wire connector 212 to which an external wire (not illustrated) provided outside the liquid ejecting head unit 2 is coupled are illustrated. A printing signal or the like for controlling the liquid ejecting head H is input from the external wire to the relay substrate 210 via the external wire connector 212, and is supplied to each liquid ejecting head H via the connector 211 of the relay substrate 210 and the wire member 110. The side wall of the flow path structure body 200 facing the external wire connector 212 is provided with an external wire opening portion 206 for inserting the external wire that is coupled to the external wire connector 212. The external wire is coupled to the external wire connector 212 of the relay substrate 210 provided inside the flow path structure body 200 via the external wire opening portion 206.

The relay substrate 210 has a second wire insertion hole 213 penetrating in the Z-axis direction. The second wire insertion hole 213 is disposed at a position that communicates with the first wire insertion hole 205, that is, at a position that overlaps the first wire insertion hole 205 when viewed in the Z-axis direction. The wire member 110 of the liquid ejecting head H is led out to the surface side of the relay substrate 210 facing the −Z direction via the first wire insertion hole 205 and the second wire insertion hole 213.

The relay substrate 210 has a protrusion portion insertion hole 214 penetrating in the Z-axis direction. A tubular protrusion portion 207 in which the second supply flow path 402 or the second recovery flow path 412 is provided is provided to protrude in the −Z direction on the surface of the second flow path structure section 202 facing the −Z direction. The protrusion portion 207 is inserted in the −Z direction of the relay substrate 210 through the protrusion portion insertion hole 214, and the second supply flow path 402 or the second recovery flow path 412 provided in the protrusion portion 207 is coupled to the third supply flow path 403 or the third recovery flow path 413.

The cover 220 is fixed to the surface of the flow path structure body 200 facing the +Z direction. The cover 220 is made of a metal plate such as stainless steel, and has a size that covers the accommodation portion 230 of the flow path structure body 200. The cover 220 is a common member that is fixed to the surfaces of the two liquid ejecting heads H facing the +Z direction. An exposure opening portion 221 that exposes the nozzle 21 of the liquid ejecting head H in the +Z direction is provided in the cover 220 independently for each liquid ejecting head H. Ink is ejected in the +Z direction from the nozzle 21 exposed from the exposure opening portion 221.

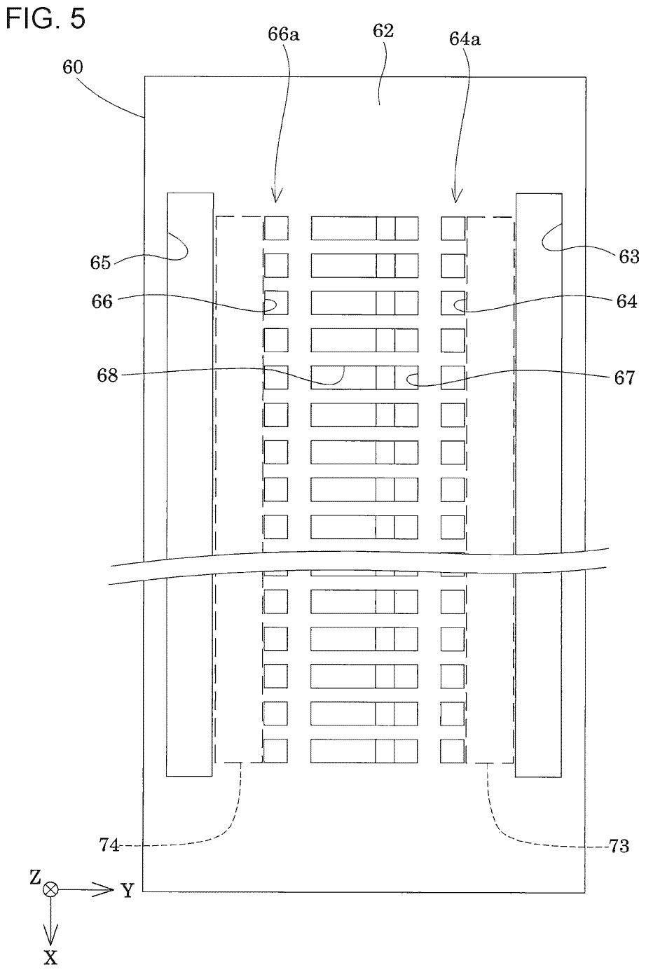

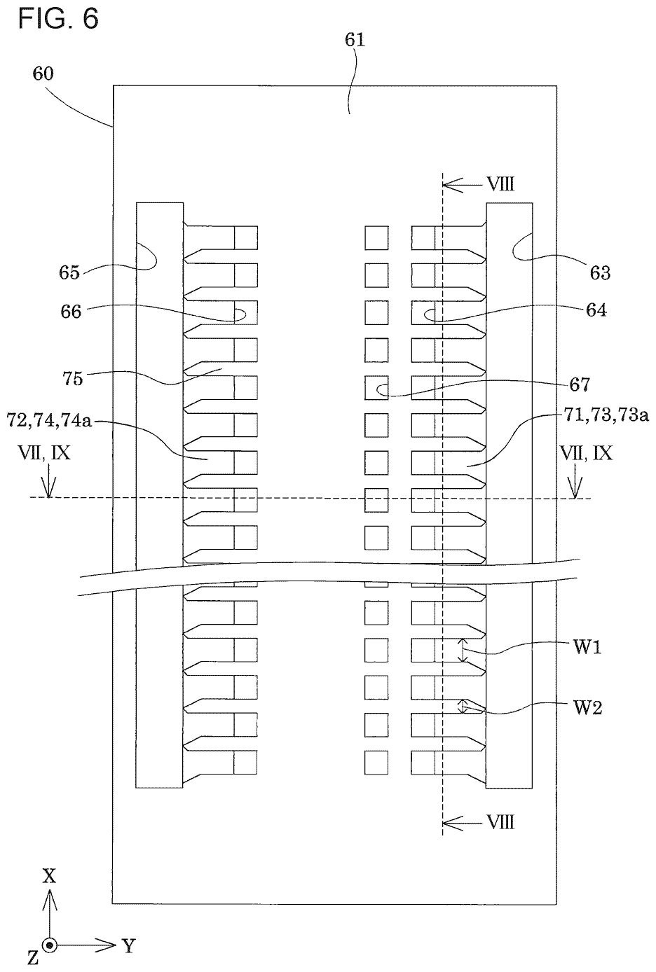

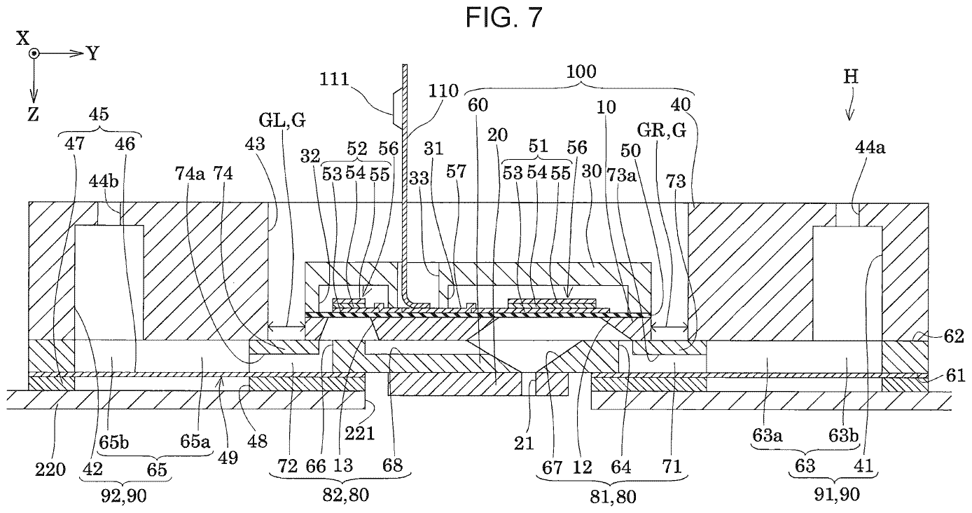

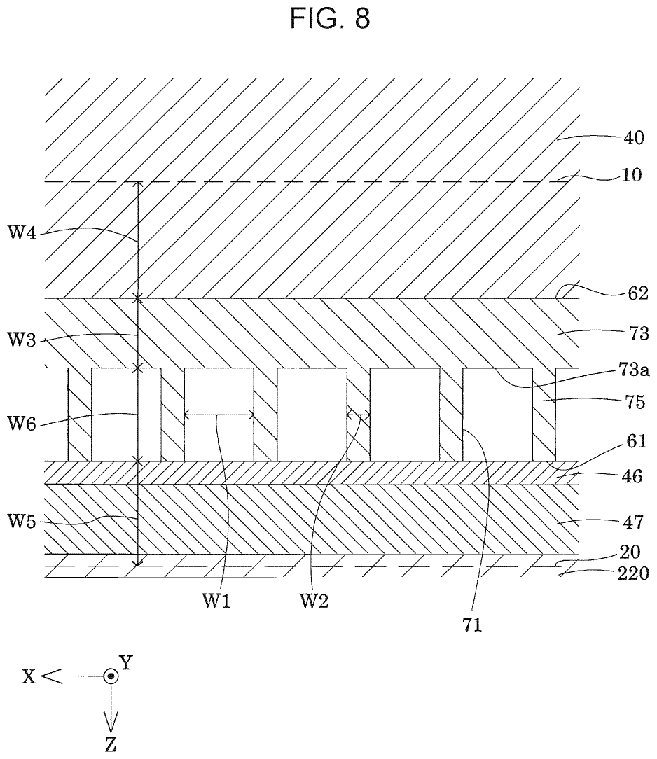

FIG. 4 is an exploded perspective view of the liquid ejecting head H according to an embodiment of the present disclosure. FIG. 5 is a top view of the communication plate when viewed in the +Z direction. FIG. 6 is a bottom view of the communication plate when viewed in the −Z direction. FIG. 7 is a sectional view of the liquid ejecting head taken along line VII-VII in FIG. 6. FIG. 8 is an enlarged sectional view of a main portion of the liquid ejecting head taken along line VIII-VIII in FIG. 6. Each direction of the liquid ejecting head H will be described based on the direction when the liquid ejecting head H is mounted on the liquid ejecting head unit 2, that is, the X-axis direction, the Y-axis direction, and the Z-axis direction.

The liquid ejecting head H of the present embodiment includes a flow path member 100, a first piezoelectric element 51, and a second piezoelectric element 52, and the flow path member 100 includes a pressure chamber substrate 10, a nozzle plate 20, a case member 40, and a communication plate 60.

The pressure chamber substrate 10 is made of, for example, a silicon substrate, a glass substrate, an SOI substrate, or various ceramic substrates. The pressure chamber substrate 10 is provided with a plurality of pressure chambers 12 and detection chambers 13 penetrating in the Z-axis direction. The plurality of pressure chambers 12 are disposed side by side along the X-axis direction to configure a pressure chamber row. Two pressure chambers 12 adjacent to each other in the X-axis direction are partitioned by a pressure chamber partition wall (not illustrated). The plurality of detection chambers 13 are disposed side by side along the X-axis direction to configure a detection chamber row. Two detection chambers 13 adjacent to each other in the X-axis direction are partitioned by a detection chamber partition wall (not illustrated). In the present embodiment, the pressure chamber row is disposed in the +Y direction, and the detection chamber row is disposed in the −Y direction. In addition, the detection chamber 13 is disposed with the same width as the width in the X-axis direction of the pressure chamber 12 and at the same pitch as the pitch in the X-axis direction of the pressure chamber 12. The detection chamber 13 is provided to have a length shorter than the length in the Y-axis direction of the pressure chamber 12.

The communication plate 60 and the nozzle plate 20 are stacked in sequence on the surface of the pressure chamber substrate 10 facing the +Z direction. A vibration plate 50, the first piezoelectric element 51, and the second piezoelectric element 52 are stacked in sequence on the surface of the pressure chamber substrate 10 facing the −Z direction.

The communication plate 60 is a plate-shaped member, and has a first surface 61 that is a surface facing the +Z direction and a second surface 62 that is a surface facing the −Z direction, and the pressure chamber substrate 10 and the case member 40 are stacked on the second surface 62. The communication plate 60 has a first through-hole 63, a second through-hole 64, a third through-hole 65, and a fourth through-hole 66 that penetrate from the first surface 61 to the second surface 62. As the communication plate 60, a single crystal silicon substrate or the like can be used.

The second surface 62 of the communication plate 60 refers to a surface on which the pressure chamber substrate 10 is stacked and a surface on the same plane as the surface on which the pressure chamber substrate 10 is stacked. The first surface 61 of the communication plate 60 refers to a surface on which the nozzle plate 20 is stacked and a surface on the same plane as the surface on which the nozzle plate 20 is stacked.

Each of the first through-hole 63 and the third through-hole 65 has a shape extending in the X-axis direction when viewed in the Z-axis direction. The first through-hole 63 is disposed in the +Y direction with respect to a second through-hole row 64a which will be described later, and the third through-hole 65 is disposed in the −Y direction with respect to a fourth through-hole row 66a which will be described later. The length in the X-axis direction of the first through-hole 63 is longer than the length of the second through-hole row 64a, and the length in the X-axis direction of the third through-hole 65 is longer than the length of the fourth through-hole row 66a. The first through-hole 63 is disposed to overlap the second through-hole row 64a when viewed in the Y-axis direction, and the third through-hole 65 is disposed to overlap the fourth through-hole row 66a when viewed in the Y-axis direction.

A plurality of the second through-holes 64 are disposed side by side along the X-axis direction to configure the second through-hole row 64a. A plurality of the fourth through-holes 66 are disposed side by side along the X-axis direction to configure the fourth through-hole row 66a. In the communication plate 60, the second through-hole row 64a and the fourth through-hole row 66a are disposed at an interval in the Y-axis direction between the first through-hole 63 and the third through-hole 65. Each second through-hole 64 included in the second through-hole row 64a communicates with each pressure chamber 12. Each fourth through-hole 66 included in the fourth through-hole row 66a communicates with each detection chamber 13.

In addition, the communication plate 60 is provided with a nozzle communication path 67 penetrating from the first surface 61 to the second surface 62. The nozzle communication path 67 is formed in a plurality of pieces such that each nozzle communication path 67 causes each pressure chamber 12 and each nozzle 21 to communicate with each other. In addition, the opening width of the nozzle communication path 67 is narrowed toward the first surface 61 from the second surface 62. Further, the communication plate 60 is formed with a connection flow path 68 that is recessed from the second surface 62 to the bottom surface located between the first surface 61 and the second surface 62. The connection flow path 68 extends in the Y-axis direction, and one end thereof communicates with the nozzle communication path 67. The other end of the connection flow path 68 communicates with the detection chamber 13 of the pressure chamber substrate 10 joined to the communication plate 60.

The communication plate 60 has a first wall portion 73 and a second wall portion 74.

The first wall portion 73 is a portion of the communication plate 60 disposed between the first through-hole 63 and the second through-hole 64 in the Y-axis direction, and is a portion disposed between the second surface 62 and the same plane as a first bottom surface 73a. The region between the first through-hole 63 and the second through-hole 64 also includes the region between the first through-hole 63 and the region between the second through-holes 64 adjacent to each other. That is, in a plan view when viewed in the +Z direction as illustrated in FIG. 5, the portion between the first through-hole 63 and a virtual range including the second through-hole row 64a is the first wall portion 73. The first bottom surface 73a is a surface located between the first surface 61 and the second surface 62 in the Z-axis direction.

The second wall portion 74 is a portion of the communication plate 60 disposed between the third through-hole 65 and the fourth through-hole 66, and is a portion disposed between the second surface 62 and the same plane as a second bottom surface 74a. The region between the third through-hole 65 and the fourth through-hole 66 also includes the region between the third through-hole 65 and the region between the fourth through-holes 66 adjacent to each other. That is, in a plan view when viewed in the +Z direction as illustrated in FIG. 5, the portion between the third through-hole 65 and a virtual range including the fourth through-hole row 66a is the second wall portion 74. The second bottom surface 74a is a surface located between the first surface 61 and the second surface 62. The first bottom surface 73a and the second bottom surface 74a are the same plane, but are not limited thereto, and may be different planes.

A plurality of partition walls 75 that are disposed in the +Z direction with respect to the first wall portion 73 and extend in the Y-axis direction are provided at intervals in the X-axis direction on the first wall portion 73. The first bottom surface 73a of the first wall portion 73 and a set of partition walls 75 facing each other define one first recessed portion 71. By providing the plurality of partition walls 75 on the first wall portion 73, the plurality of first recessed portions 71 recessed from the first surface 61 to the first bottom surface 73a and separated by the plurality of partition walls 75 are arranged side by side in the X-axis direction on the communication plate 60. The same number of first recessed portions 71 as the number of the plurality of pressure chambers 12 are provided, and each first recessed portion 71 couples the end portion in the −Y direction of the first through-hole 63 and the end portion in the +Y direction of each second through-hole 64. The first recessed portion 71 has an end portion in the +Y direction, which overlaps the case member 40, an end portion in the −Y direction, which overlaps the pressure chamber substrate 10, and a region near the center overlapping a gap GR described later, when viewed in the Z-axis direction.

A plurality of partition walls 75 that are disposed in the +Z direction with respect to the second wall portion 74 and extend in the Y-axis direction are provided at intervals in the X-axis direction on the second wall portion 74. The second bottom surface 74a of the second wall portion 74 and a set of partition walls 75 facing each other define one second recessed portion 72. By providing the plurality of partition walls 75 on the second wall portion 74, the plurality of second recessed portions 72 recessed from the first surface 61 to the second bottom surface 74a and separated by the plurality of partition walls 75 are arranged side by side in the X-axis direction on the communication plate 60. The same number of the second recessed portions 72 as the number of the plurality of detection chambers 13 are provided, and each second recessed portion 72 couples the end portion in the +Y direction of the third through-hole 65 and the end portion in the −Y direction of each fourth through-holes 66. The second recessed portion 72 has an end portion in the −Y direction, which overlaps the case member 40, an end portion in the +Y direction, which overlaps the pressure chamber substrate 10, and a region near the center overlapping a gap GL described later, when viewed in the Z-axis direction.

The shape of the partition wall 75 is not particularly limited. However, in the present embodiment, as illustrated in FIG. 6, the partition wall 75 defining the first recessed portion 71 has a width reduced in the X-axis direction toward the first through-hole 63, and the partition wall 75 defining the second recessed portion 72 has a width reduced in the X-axis direction toward the third through-hole 65. In addition, as illustrated in FIG. 8, a width W1 in the X-axis direction of the first recessed portion 71 is larger than a width W2 in the X-axis direction of the partition wall 75. In addition, the minimum width in the X-axis direction of the second recessed portion 72 is larger than the width W2 in the X-axis direction of the partition wall 75. The width W2 of the partition wall 75 refers to the maximum width in the X-axis direction of the partition wall 75. The width W1 in the X-axis direction of the first recessed portion 71 is the minimum width in the X-axis direction of the first recessed portion 71. As in the present embodiment, for the partition wall 75 of which the width in the X-axis direction is not constant, the maximum width in the X-axis direction of the partition wall 75 is set as the width W2, and for the first recessed portion 71 of which the width in the X-axis direction is not constant, the minimum width in the X-axis direction of the first recessed portion 71 is set as the width W1, and it is preferable that the width W1 of the first recessed portion 71 is larger than the width W2.

As illustrated in FIG. 8, a width W3 in the Z-axis direction of the first wall portion 73 is a width in the +Z direction from the second surface 62 to the first bottom surface 73a. The width W3 is not particularly limited. However, it is preferable to satisfy one or more of the following conditions.

The width W3 is smaller than a width W4 in the +Z direction of the pressure chamber substrate 10.

The width W3 is smaller than a width W5 in the +Z direction of the nozzle plate 20.

The width W3 is equal to or less than a width W6 in the +Z direction of the first recessed portion 71.

The width W3 is 150 μm or less.

In addition, the width W3 of the first wall portion 73 is preferably ½ or less, more preferably ⅓ or less, and even more preferably ¼ or less of the width in the Z-axis direction of the communication plate 60.

In addition, the width in the Z-axis direction of the second wall portion 74 is the width in the +Z direction from the second surface 62 to the second bottom surface 74a. The width in the Z-axis direction of the second wall portion 74 is not particularly limited. However, it is preferable to satisfy one or more of the following conditions.

The width is smaller than the width W4 in the +Z direction of the pressure chamber substrate 10.

The width is smaller than the width W5 in the +Z direction of the nozzle plate 20.

The width is equal to or less than the width in the +Z direction of the second recessed portion 72.

The width is 150 μm or less.

In addition, the width of the second wall portion 74 is preferably ½ or less, more preferably ⅓ or less, and even more preferably ¼ or less of the width in the Z-axis direction of the communication plate 60.

The first recessed portion 71 and the second recessed portion 72 are formed by the partition wall 75 extending in the Y-axis direction. However, the present disclosure is not limited thereto. The first recessed portion 71 and the second recessed portion 72 may extend in any direction, and do not need to be linear and may be bent. In addition, the first recessed portion 71 is illustrated as having a configuration in which the depth from the first surface 61 to the first bottom surface 73a is constant. However, the present disclosure is not limited thereto. For example, the first bottom surface 73a of the first recessed portion 71 may be inclined with respect to the XY plane. The same applies to the second bottom surface 74a of the second recessed portion 72.

The nozzle plate 20 is joined to the surface of the communication plate 60 facing the +Z direction. The nozzle plate 20 is formed with the nozzle 21 which communicates with each of the pressure chambers 12 through the nozzle communication path 67. In the present embodiment, a plurality of nozzles 21 are disposed side by side in a row along the X-axis direction. One nozzle row including the nozzles 21 arranged side by side along the X-axis direction is provided. The material of the nozzle plate 20 is not particularly limited, and for example, a silicon substrate or the like can be used.

The case member 40 is a member that is stacked on the second surface 62 of the communication plate 60 and located in the −Z direction with respect to the second surface 62, and is a member that configures a portion of a common flow path 90 which will be described later. The case member 40 has substantially the same shape as the communication plate 60 in a plan view when viewed in the +Z direction. The material of the case member 40 is a metal material, a resin material, or the like. The case member 40 is provided with a first common liquid chamber portion 41 and a second common liquid chamber portion 42.

The first common liquid chamber portion 41 is a recessed portion of the case member 40 which is open in the +Z direction, and the opening communicates with a portion of the first through-hole 63. In the first through-hole 63, the portion coupled to the first common liquid chamber portion 41 is a second portion 63b, and the portion blocked by the surface of the case member 40 facing the +Z direction is a first portion 63a. That is, the first through-hole 63 has the second portion 63b coupled to the first common liquid chamber portion 41, and the first portion 63a coupled to the second portion 63b and blocked by the surface of the case member 40 facing the +Z direction. The second portion 63b is a portion that is not blocked by the surface of the case member 40 facing the +Z direction. The second portion 63b is a portion that overlaps the first common liquid chamber portion 41 in the Z-axis direction, and the first portion 63a is a portion that does not overlap the first common liquid chamber portion 41 in the Z-axis direction.

The second common liquid chamber portion 42 is a recessed portion of the case member 40 which is open in the +Z direction, and the opening communicates with a portion of the third through-hole 65. In the third through-hole 65, the portion coupled to the second common liquid chamber portion 42 is a fourth portion 65b, and the portion blocked by the surface of the case member 40 facing the +Z direction is a third portion 65a. That is, the third through-hole 65 has the fourth portion 65b coupled to the second common liquid chamber portion 42, and the third portion 65a coupled to the fourth portion 65b and blocked by the surface of the case member 40 facing the +Z direction. The fourth portion 65b is a portion that is not blocked by the surface of the case member 40 facing the +Z direction. The fourth portion 65b is a portion that overlaps the second common liquid chamber portion 42 in the Z-axis direction, and the third portion 65a is a portion that does not overlap the second common liquid chamber portion 42 in the Z-axis direction.

The case member 40 is stacked on the second surface 62 of the communication plate 60, and has a case opening portion 43 that is a through-hole larger than the pressure chamber substrate 10 in a plan view when viewed in the +Z direction. The pressure chamber substrate 10 is disposed inside the case opening portion 43. A gap G is provided between the pressure chamber substrate 10 and the inner peripheral surface of the case opening portion 43. The gap G is a gap in the Y-axis direction between the pressure chamber substrate 10 and the inner peripheral surface of the case opening portion 43 when viewed in the X-axis direction. In the present embodiment, the gaps G are provided on both sides of the pressure chamber substrate 10 in the Y-axis direction. The gap G provided in the +Y direction is also referred to as the gap GR, and the gap G provided in the −Y direction is also referred to as the gap GL. The gap GR is disposed in the +Y direction of the pressure chamber substrate 10, and the case member 40 is disposed in the +Y direction of the gap GR. The gap GL is disposed in the −Y direction of the pressure chamber substrate 10, and the case member 40 is disposed in the −Y direction of the gap GL.

The case member 40 is provided with the introduction port 44a and the outlet 44b. The introduction port 44a and the outlet 44b are provided to be open on the surface of the case member 40 facing the −Z direction, and the introduction port 44a is a flow path that couples the first common liquid chamber portion 41 and the supply flow path 400. The outlet 44b is a flow path that couples the second common liquid chamber portion 42 and the recovery flow path 410.

A compliance substrate 45 is provided on the surface of the communication plate 60 facing the +Z direction. The compliance substrate 45 has a flexible member 46 and a support body 47. The flexible member 46 is made of a thin film having flexibility. The flexible member 46 is stacked on the first surface 61 of the communication plate 60, and defines the first recessed portion 71, the second recessed portion 72, the first through-hole 63, the second through-hole 64, the third through-hole 65, and the fourth through-hole 66. That is, the openings facing the +Z direction, of the first recessed portion 71, the second recessed portion 72, the first through-hole 63, the second through-hole 64, the third through-hole 65, and the fourth through-hole 66, are sealed by the flexible member 46. The support body 47 is made of a hard material such as metal, and is a member that fixes the flexible member 46 to the communication plate 60. The support body 47 has an opening portion 48 which is a through-hole provided in a portion facing the first through-hole 63 and the third through-hole 65. That is, the opening portion 48 is disposed in the +Z direction of the first through-hole 63 and the third through-hole 65. The support body 47 is disposed at least in the +Z direction of the first recessed portion 71 and the second recessed portion 72 with the flexible member 46 interposed therebetween. Although not illustrated in the drawings, the flexible member 46 is bonded to the communication plate 60, and the support body 47 is bonded to the flexible member 46. Of course, the fixing of the flexible member 46 and the support body 47 is not limited to the bonding, and may be performed by other known fixing means.

In the present embodiment, the support body 47 is disposed in the +Z direction of the opening edge portions of the partition wall 75, the second through-hole 64, the fourth through-hole 66, and the first through-hole 63, in addition to the first recessed portion 71 and the second recessed portion 72. The portion of the flexible member 46 exposed to the opening portion 48 is a compliance portion 49. That is, the support body 47 defines the compliance portion 49 that can be bent and deformed inside the opening portion 48. The cover 220 is joined to the surface of the compliance substrate 45 facing the +Z direction. Although not particularly illustrated in the drawings, the space between the cover 220 and the flexible member 46 is open to the atmosphere, and the compliance portion 49 of the flexible member 46 is deformable according to the pressure of the ink which is applied to the compliance portion 49.

The pressure chamber substrate 10 and the case member 40 are stacked on the second surface 62 of the communication plate 60, and the nozzle plate 20 and the compliance substrate 45 are stacked on the first surface 61 of the communication plate 60. In this way, an individual flow path 80 and the common flow path 90 are formed.

The individual flow path 80 is a flow path that individually communicates with each of the plurality of nozzles 21, and in the present embodiment, the individual flow path 80 has a supply individual flow path 81 and a recovery individual flow path 82. The supply individual flow path 81 is a flow path for supplying ink to the nozzle 21, and is a flow path formed for each nozzle 21. Specifically, the supply individual flow path 81 has a space defined by the first recessed portion 71, the second through-hole 64, the pressure chamber 12, and the nozzle communication path 67. The recovery individual flow path 82 is a flow path for recovering the ink that is not ejected from the nozzle 21, and is a flow path formed for each nozzle 21. Specifically, the recovery individual flow path 82 has the connection flow path 68, the detection chamber 13, the fourth through-hole 66, and the second recessed portion 72.

The common flow path 90 is a flow path that commonly communicates with the plurality of individual flow paths 80, and in the present embodiment, the common flow path 90 has a supply common flow path 91 and a recovery common flow path 92. The supply common flow path 91 is a flow path that communicates with the plurality of supply individual flow paths 81. Specifically, the supply common flow path 91 has the first common liquid chamber portion 41 and the first through-hole 63. The recovery common flow path 92 is a flow path that communicates with the plurality of recovery individual flow paths 82. Specifically, the recovery common flow path 92 has the third through-hole 65 and the second common liquid chamber portion 42.

A configuration in which one common flow path 90 is provided to commonly communicate with the plurality of individual flow paths 80 is illustrated as an example. However, the present disclosure is not limited thereto. For example, a plurality of common flow paths 90 may be provided, and a plurality of individual flow paths may communicate with each of the plurality of common flow paths 90. A configuration in which each of the plurality of individual flow paths 80 supplies ink to one nozzle 21 is illustrated as an example. However, the present disclosure is not limited thereto. For example, a configuration may be adopted in which each of the plurality of individual flow paths 80 supplies ink to two or more nozzles 21. Each of the plurality of individual flow paths 80 includes the pressure chamber 12 and the detection chamber 13. However, the detection chamber 13 does not need to be provided in all the individual flow paths 80, and the detection chambers 13 may be provided in only some of the individual flow paths 80, or the detection chamber 13 does not need to be provided in all the individual flow paths 80.

The vibration plate 50 is provided on the surface in the −Z direction of the pressure chamber substrate 10, and seals the openings of the pressure chamber 12 and the detection chamber 13 facing the −Z direction. The vibration plate 50 is made of, for example, an elastic film made of silicon oxide and an insulator film made of zirconium oxide provided on the surface of the elastic film facing the −Z direction, although not particularly illustrated in the drawings. In the present embodiment, the vibration plate 50 is common to the first piezoelectric element 51 and the second piezoelectric element 52. However, the present disclosure is not limited thereto. The stacked structure such as a film thickness or a material may be different for each of the first piezoelectric element 51 and the second piezoelectric element 52. In addition, the vibration plate 50 and the pressure chamber substrate 10 may be integrally formed.

The first piezoelectric element 51 is used as a drive element that applies voltage between electrodes to generate vibration in the vibration plate 50, thereby causing a pressure change in the ink in the pressure chamber 12. The second piezoelectric element 52 is used as a detection element that detects the vibration that is applied to the vibration plate 50. The first piezoelectric element 51 includes a first electrode 53, a piezoelectric body layer 54 made using a piezoelectric material formed of a composite oxide having a perovskite structure represented by, for example, a general formula ABO3, and a second electrode 55, which are stacked in sequence on the vibration plate 50 in the −Z direction. The second piezoelectric element 52 also has the same configuration as the first piezoelectric element 51. Each of the first piezoelectric element 51 and the second piezoelectric element 52 as described above refers to a portion including the first electrode 53, the piezoelectric body layer 54, and the second electrode 55. In addition, a portion where piezoelectric strain occurs in the piezoelectric body layer 54 when voltage is applied between the first electrode 53 and the second electrode 55 is referred to as an active portion 56. Meanwhile, a portion where piezoelectric strain does not occur in the piezoelectric body layer 54 is referred to as an inactive portion. That is, the active portion 56 is a portion where the piezoelectric body layer 54 is interposed between the first electrode 53 and the second electrode 55. In the present embodiment, the active portion 56 is formed for each of the pressure chambers 12 and each of the detection chambers 13. That is, the first piezoelectric element 51 has a plurality of active portions 56 arranged side by side in the X-axis direction to face the plurality of pressure chambers 12 arranged side by side in the X-axis direction. Similarly, the second piezoelectric element 52 has a plurality of active portions 56 arranged side by side in the X-axis direction to face the plurality of detection chambers 13 arranged side by side in the X-axis direction. Generally, one electrode of the active portion 56 is configured as an individual electrode independent for each active portion 56, and the other electrode is configured as a common electrode common to the plurality of active portions 56. In the present embodiment, the first electrode 53 is configured as an individual electrode, and the second electrode 55 is configured as a common electrode.

An individual lead electrode 57, which is a lead-out wire, is drawn from the first electrodes 53 of the first piezoelectric element 51 and the second piezoelectric element 52. A common lead electrode (not illustrated), which is a lead-out wire, is drawn from the second electrode 55. The wire member 110 made of a flexible substrate having flexibility is coupled to the end portions of the individual lead electrodes 57 and the common lead electrode on a side opposite to the end portions which are coupled to the first piezoelectric element 51 and the second piezoelectric element 52. The wire member 110 is provided with a drive circuit 111 having a plurality of switching elements for selecting whether or not to supply a drive signal (COM) for driving each of the active portions 56 of the first piezoelectric element 51 to each active portion 56. Further, a detection signal or the like corresponding to the vibration generated in the second piezoelectric element 52 is transmitted between the control section 4 and the second piezoelectric element 52 via the wire member 110. The wire member 110 is a chip on film (COF). However, the wire member 110 does not need to be provided with the drive circuit 111. That is, the wire member 110 may be a flexible flat cable (FFC), a flexible printed circuit (FPC), or the like.

A protective substrate 30 having substantially the same size as the pressure chamber substrate 10 is joined to the surface of the pressure chamber substrate 10 facing the −Z direction. The protective substrate 30 has a first accommodation portion 31 and a second accommodation portion 32, which are spaces for protecting the first piezoelectric element 51 and the second piezoelectric element 52. The first accommodation portion 31 accommodates the plurality of first piezoelectric elements 51 disposed side by side in the X-axis direction, and the second accommodation portion 32 accommodates the plurality of second piezoelectric elements 52 arranged side by side in the X-axis direction. A through-hole 33 that penetrates in the Z-axis direction is provided in the protective substrate 30 between the first accommodation portion 31 and the second accommodation portion 32. The end portions of the individual lead electrodes 57 and the common lead electrode drawn from the electrodes of the first piezoelectric element 51 and the second piezoelectric element 52 extend to be exposed in the through-hole 33, and the individual lead electrodes 57, the common lead electrode, and the wire member 110 are electrically coupled to each other in the through-hole 33. The protective substrate 30 is made of, for example, a silicon substrate or the like.

In the liquid ejecting head unit 2 as described above, ink is supplied to the supply flow path 400 of the flow path structure body 200 coupled to the sub-tank 3b. The foreign matter such as dust or air bubbles contained in the ink is removed by the filter 406 provided in the flow path structure body 200, and the ink is supplied to the supply common flow path 91 via the introduction port 44a of the liquid ejecting head H. Ink is supplied from the supply common flow path 91 to each of the plurality of supply individual flow paths 81. Voltage is applied to the active portion 56 of each of the first piezoelectric elements 51 corresponding to the pressure chamber 12 according to the recording signal from the drive circuit 111. In this way, the vibration plate 50 is bent and deformed together with the active portion 56, the pressure of the ink in each pressure chamber 12 is increased, and ink droplets are ejected from each nozzle 21. The ink not ejected from the nozzle 21 flows through the recovery individual flow path 82 and merges in the recovery common flow path 92, and is recovered to the sub-tank 3b from the recovery common flow path 92 via the outlet 44b and the recovery flow path 410.

The liquid ejecting head H described above includes the flow path member 100 having the plurality of nozzles 21 that eject a liquid such as ink in the +Z direction, the plurality of individual flow paths 80 that individually communicate with the plurality of nozzles 21, and the common flow path 90 that commonly communicates with the plurality of individual flow paths 80, in which the flow path member 100 includes the pressure chamber substrate 10 that is provided with the pressure chamber 12 which is a portion of the individual flow path 80 and in which pressure is applied to ink to eject the ink, and the communication plate 60 that is provided with the nozzle communication path 67 which is a portion of the individual flow path 80 and communicates with the nozzle 21 and the pressure chamber 12, and that has the second surface 62 which is a surface in the −Z direction, the pressure chamber substrate 10 is stacked on the second surface 62, the case member 40 that is located in the −Z direction with respect to the second surface 62 is disposed on the second surface 62 via the gap GR in the Y-axis direction that is a direction orthogonal to the +Z direction and the −Z direction of the pressure chamber substrate 10, the communication plate 60 has the plurality of first recessed portions 71 which are recessed from the first surface 61 of the communication plate 60 to the first bottom surface 73a located between the first surface 61 and the second surface 62, and some of which overlap the gap G when viewed in the +Z direction, and the space defined by the first recessed portion 71 is a portion of the individual flow path 80.

That is, in the liquid ejecting head H, among the flow paths provided in the communication plate 60, the flow path overlapping the gap GR between the pressure chamber substrate 10 and the case member 40 in the Z-axis direction is a space defined by the first recessed portion 71 and is a portion of the individual flow path 80.

In a configuration in which the flow path overlapping the gap GR between the pressure chamber substrate 10 and the case member 40 in the Z-axis direction is not a space defined by the first recessed portion 71 but is a portion of the common flow path 90 common to each nozzle 21, a configuration is made in which the partition wall 75 of the configuration illustrated in FIG. 8 is not present, and a portion of one common flow path common to each nozzle 21 is present in the communication plate. In such a configuration, the rigidity of the communication plate 60 is relatively low.

On the other hand, in the liquid ejecting head H of the present embodiment, by providing the first recessed portion 71 as a portion of the individual flow path 80 in the communication plate 60, the rigidity of the communication plate 60 can be improved, and the deformation and cracking of the communication plate 60 when an external force such as a collision with the medium S is applied to the surface of the liquid ejecting head H facing the +Z direction can be suppressed. When the communication plate 60 is formed of a single crystal silicon substrate, the communication plate 60 is relatively easy to crack. However, even when such a communication plate 60 is used, the rigidity can be improved by the first recessed portion 71, as described above.

In addition, as described in the related art, it is desired to discharge ink at a high speed without reducing the discharge amount of the ink, and therefore, it is effective to shorten the flow path length from the pressure chamber 12 to the nozzle 21. The reason is as follows. In order to make it possible for the ink to be discharged at a high speed, it is necessary to shorten a natural vibration period Tc inside the pressure chamber, which is represented by the following equation.

$$Tc = 2 π √ \{ M ( C 1 + C 2 ) \}$$

The natural vibration period Tc is proportional to inertance M due to the weight of ink in the flow path, compliance C1 of the flow path, and compliance C2 of the vibration plate 50. C1 is proportional to the volume of ink. The reduction of C2 can be achieved by making the vibration plate 50 hard. However, the vibration plate 50 is not easily deformed, so that the discharge amount of ink is reduced. Therefore, by shortening the flow path length of the flow path from the surface of the vibration plate 50 facing the +Z direction to the nozzle 21 and the flow path lengths of the pressure chamber 12 and the nozzle communication path 67 in the above-described embodiment, the weight and volume of the ink can be reduced. Therefore, the inertance M and C1 due to the weight of the ink are reduced, and the natural vibration period Tc can be reduced. In order to make the flow path length from the surface of the vibration plate 50 facing the +Z direction to the nozzle 21 as short as possible, it is necessary to reduce the width in the Z-axis direction of the communication plate 60. That is, it is necessary to make the communication plate 60 thin. When the communication plate 60 is made thin, the widths in the Z-axis direction of the first wall portion 73 and the second wall portion 74 also need to be smaller than those in the related art, and therefore, there is a concern that the rigidity of the first wall portion 73 and the second wall portion 74 may be lowered.

For such a reason, even when the thin communication plate 60 is adopted, in the liquid ejecting head H of the present embodiment, by providing the first recessed portion 71 as a portion of the individual flow path 80 on the communication plate 60, the rigidity can be secured as compared with a configuration in which a portion of the common flow path 90 is provided.

In the present embodiment, the ink is supplied from the supply common flow path 91 to the nozzle 21, the ink that is not ejected is recovered via the recovery common flow path 92, and the ink is circulated. However, the present disclosure is not limited to such a configuration. That is, the present disclosure can also be applied to a liquid ejecting head having a configuration in which the recovery individual flow path 82 and the recovery common flow path 92 are not provided and the ink not ejected from the nozzle 21 is not recovered. The +Z direction is an example of the “first direction”, the −Z direction is an example of the “second direction”, and the Y-axis direction is an example of the “third direction”. The nozzle communication path 67 is an example of the “flow path which causes the nozzle and the pressure chamber to communicate with each other”. The case member 40 is an example of the “flow path section”. The first recessed portion 71 is an example of the “first recessed portion”. However, the second recessed portion 72 may be an example of the “first recessed portion”.

In the liquid ejecting head H of the present embodiment, the communication plate 60 has the first through-hole 63 and the second through-hole 64 penetrating from the first surface 61 to the second surface 62, the first wall portion 73 which is a portion disposed between the first through-hole 63 and the second through-hole 64 and which is a portion disposed between the second surface 62 and the same plane as the first bottom surface 73a, and the plurality of partition walls 75 which are disposed in the +Z direction with respect to the first wall portion 73 and separate the plurality of first recessed portions 71 adjacent to each other, a portion of the common flow path 90 is defined by the first through-hole 63, a portion of the individual flow path 80 is defined by the second through-hole 64, and the first recessed portion 71 couples the first through-hole 63 and the second through-hole 64. The first wall portion 73 is an example of the “wall portion which is a portion disposed between the first through-hole and the second through-hole and which is a portion disposed between the second surface and the same plane as the bottom surface”.

In the liquid ejecting head H of the present embodiment, the plurality of first recessed portions 71 are arranged in the X-axis direction, and the width W1 in the X-axis direction of the first recessed portion 71 is larger than the width W2 in the X-axis direction of the partition wall 75. By making the width W2 of the partition wall 75 small and making the width W1 of the first recessed portion 71, which is a portion of the individual flow path 80, large, a pressure loss of the ink due to the narrowing of the width of the individual flow path 80 can be reduced. Even when the width W2 of the partition wall 75 is small, the plurality of partition walls 75 have less influence on a decrease in the rigidity of the first wall portion 73. The X-axis direction is an example of the “fourth direction”. In addition, the width W1 is not limited to a case where the width W1 is larger than the width W2, and the width W1 may be equal to or less than the width W2.

In the liquid ejecting head H of the present embodiment, the width in the X-axis direction of the partition wall 75 is reduced toward the first through-hole 63. The first recessed portion 71 is formed as a portion of the individual flow path 80 in the first wall portion 73 facing the gap GR on the communication plate 60, so that the flow path cross-sectional area is reduced as compared with a configuration in which a portion of the individual flow path 80 is not provided, and therefore, the ink does not easily flow from the supply common flow path 91 into each first recessed portion 71. However, the width of the partition wall 75 is reduced toward the first through-hole 63. In other words, the width in the X-axis direction of the first recessed portion 71 becomes wider toward the supply common flow path 91, and the cross-sectional area of the first recessed portion 71 becomes larger. Therefore, the ink easily flows from the supply common flow path 91 into each first recessed portion 71. Similarly, the air bubble discharge performance from the supply common flow path 91 to the supply individual flow path 81 can be improved. In addition, a pressure loss of the ink can be reduced.

In the liquid ejecting head H of the present embodiment, the liquid ejecting head H includes the flexible member 46 having flexibility, which is stacked in the +Z direction of the communication plate 60 and define the plurality of first recessed portions 71, the first through-hole 63, and the second through-hole 64, and the support body 47 that is stacked in the +Z direction of the flexible member 46 and fixes the flexible member 46, and the support body 47 is disposed in the +Z direction of the first recessed portion 71 with the flexible member 46 interposed therebetween.

As described in the related art, a portion of the individual flow path 80 defined by the first recessed portion 71 is also reduced in thickness as the thickness of the communication plate 60 is reduced. Therefore, when the flexible member 47 is bent and deformed toward the individual flow path 80, there is a concern that the individual flow path 80 may be blocked. However, in the liquid ejecting head H of the present embodiment, the support body 47 is disposed in the +Z direction of the first recessed portion 71 with the flexible member 46 interposed therebetween. Since the deformation of a portion of the flexible member 46 that defines the first recessed portion 71 can be suppressed by the support body 47, a portion of the individual flow path 80 that is configured by the first recessed portion 71 can be suppressed from being blocked by the flexible member 46. Further, the support body 47 is disposed in the +Z direction of the first recessed portion 71 with the flexible member 46 interposed therebetween, so that the rigidity of the individual flow path is increased. In addition, the opening portion 48 formed in the support body 47 is located in the +Z direction of the first through-hole 63. Therefore, the flexible member 46 can be deformed in the first through-hole 63. In this way, a pressure fluctuation of the ink can be absorbed in the first through-hole 63.

In the liquid ejecting head H of the present embodiment, the first through-hole 63 has the second portion 63b that is coupled to the first common liquid chamber portion 41 provided in the case member 40, and the first portion 63a that is coupled to the second portion 63b and is blocked by the surface in the +Z direction of the case member 40.

In the liquid ejecting head H described above, the first portion 63a of the first through-hole 63 is not a portion of the individual flow path 80 and is a portion of the common flow path 90. Therefore, the width in the Y-axis direction of the first recessed portion 71 can be reduced as compared with a configuration in which the first recessed portion 71 extends to the boundary between the first portion 63a and the second portion 63b in the Y-axis direction and the first recessed portion 71 is also formed in the first portion 63a. In this way, a pressure loss of the ink in the first recessed portion 71 can be reduced. In addition, the width in the Y-axis direction of the supply common flow path 91 can be increased by an amount corresponding to the first portion 63a. Therefore, the flexible member 46 can be deformed not only in the second portion 63b but also in the first portion 63a, and the absorption of a pressure fluctuation of the ink in the first through-hole 63 can be increased. The first through-hole 63 has the first portion 63a and the second portion 63b. However, the present disclosure is not limited to such a configuration. A configuration may be made such that the entire opening of the first through-hole 63 communicates with the first common liquid chamber portion 41 of the case member 40, that is, the first through-hole 63 includes only the second portion 63b.

In the liquid ejecting head H of the present embodiment, the communication plate 60 has the plurality of second recessed portions 72 which are recessed from the first surface 61 to the second bottom surface 74a located between the first surface 61 and the second surface 62, and some of which overlap the gap GL when viewed in the +Z direction, the individual flow path 80 has the supply individual flow path 81 for supplying ink to the nozzle 21, and the recovery individual flow path 82 for recovering the ink not ejected from the nozzle 21, the common flow path 90 has the supply common flow path 91 communicating with the plurality of supply individual flow paths 81, and the recovery common flow path 92 communicating with the plurality of recovery individual flow paths 82, and one of the space defined by the first recessed portion 71 and the space defined by the second recessed portion 72 is a portion of the supply individual flow path 81, and the other is a portion of the recovery individual flow path 82. The supply individual flow path 81 is an example of the “space defined by the first recessed portion”, and the recovery individual flow path 82 is an example of the “space defined by the second recessed portion”.

In the liquid ejecting head H of the present embodiment, the width W3 in the +Z direction from the second surface 62 to the first bottom surface 73a, that is, the width W3 of the first wall portion 73 is smaller than the width W4 in the +Z direction of the pressure chamber substrate 10. In addition, in the liquid ejecting head H of the present embodiment, the flow path member 100 includes the nozzle plate 20 provided with the plurality of nozzles 21, and the width W3 in the +Z direction from the second surface 62 to the first bottom surface 73a is smaller than the width W5 in the +Z direction of the nozzle plate 20. As described above, the width W3 of the first wall portion 73 of the communication plate 60 is thinner than the pressure chamber substrate 10 or the nozzle plate 20, and the first wall portion 73 is relatively easy to crack. However, as described above, the rigidity can be improved by forming the plurality of first recessed portions 71.

In the liquid ejecting head H of the present embodiment, the width W3 in the +Z direction from the second surface 62 to the first bottom surface 73a is equal to or less than the width W6 in the +Z direction of the first recessed portion 71. When the cross-sectional area of a portion of the individual flow path 80 defined by the first recessed portion 71 is small, a pressure loss of ink increases. Therefore, by making the width W3 of the first wall portion 73 equal to or less than the width W6 of the first recessed portion 71, the width in the +Z direction of the first recessed portion 71 can be increased, and the pressure loss of ink can be reduced.

In the liquid ejecting head H of the present embodiment, the width W3 in the +Z direction from the second surface 62 to the first bottom surface 73a is 150 μm or less. The 150 μm is an example, and the width W3 is more preferably 80 μm or more and 150 μm or less.

One embodiment of the present disclosure is described above. However, the basic configuration of the present disclosure is not limited to the embodiment described above.

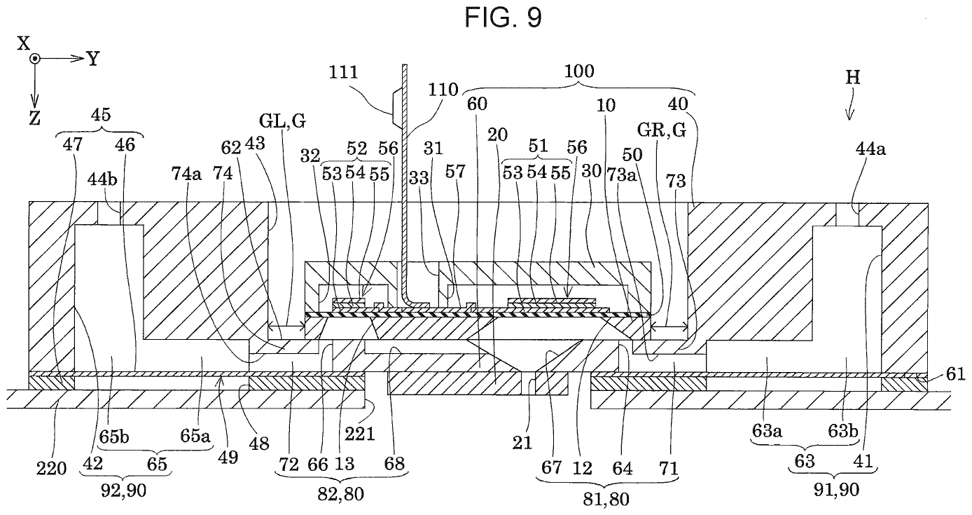

In the liquid ejecting head H of the embodiment described above, the case member 40 and the communication plate 60 are separate members. However, the case member 40 and the communication plate 60 may be made of an integral member, as in a modification example shown in FIG. 9. Here, the fact that the case member 40 and the communication plate 60 are made of an integral member means that a bonding layer made of resin is not disposed between the case member 40 and the communication plate 60, and the fact that the case member 40 and the communication plate 60 are separate members means that a bonding layer made of resin is disposed between the case member 40 and the communication plate 60. An example of a case where the bonding layer made of resin is not disposed between the case member 40 and the communication plate 60 includes a case where a layer different from the case member 40 or the communication plate 60 is not disposed between the case member 40 and the communication plate 60 due to solid phase diffusion joining or by integrally forming the case member 40 and the communication plate 60 with same mold molding. In addition, a case in which a layer of silicon oxide is disposed between the case member 40 made of single crystal silicon and the communication plate 60 made of single crystal silicon is also included. In this manner, when the case member 40 and the communication plate 60 are made of an integral member, the communication plate 60 refers to a portion, which includes the second surface 62 and is located in the +Z direction with respect to the second surface 62, of a member in which the pressure chamber substrate 10 is stacked on the second surface 62. In addition, the case member 40 is a portion located in the −Z direction with respect to the second surface 62.

In the embodiment described above, a circulation type liquid ejecting head unit 2 that supplies ink from the liquid storage section 3 and recovers the ink not ejected from the liquid ejecting head unit 2 is exemplified. However, the present disclosure is not limited thereto, and the present disclosure can also be applied to the liquid ejecting head unit 2 that does not recover ink.

In addition, in the embodiment described above, a thin film type piezoelectric actuator is described as a pressure generating unit that causes a pressure change in the pressure chamber 12. However, the configuration is not particularly limited thereto. For example, a thick film type piezoelectric actuator formed by a method such as attaching a green sheet, or a longitudinal vibration type piezoelectric actuator that expands and contracts in the axial direction by alternately stacking a piezoelectric material and an electrode forming material, or the like can be used. In addition, as the pressure generating unit, a so-called electrostatic actuator that generates static electricity between a vibration plate and an electrode, deforms the vibration plate by an electrostatic force, and discharges liquid droplets from a nozzle opening, or the like can be used.

In addition, in the liquid ejecting apparatus 1 described above, a case where the liquid ejecting head unit 2 is mounted on the holding body 6a and moves in the Y-axis direction, which is a main scanning direction, is described as an example. However, the present disclosure is not particularly limited thereto, and the present disclosure can be applied to, for example, a so-called line type recording apparatus in which printing is performed by fixing the liquid ejecting head unit 2 and moving the medium S such as paper in the X-axis direction.

Furthermore, the present disclosure is broadly applicable to liquid ejecting heads in general, and examples thereof include recording heads, such as various types of ink jet type recording heads used in image recording apparatus, such as printers, a color material ejecting head used for manufacturing a color filter, such as a liquid crystal display, an electrode material ejecting head used for forming electrodes, such as an organic EL display or a field emission display (FED), and a bioorganic material ejecting head used for manufacturing a bio chip.

### Additional Remarks

From the above-described embodiment, for example, the following configurations can be understood.
A liquid ejecting head according to Aspect 1 that is a preferred aspect includes: a flow path member having a plurality of nozzles that eject a liquid in a first direction, a plurality of individual flow paths that individually communicate with the plurality of nozzles, and a common flow path that commonly communicates with the plurality of individual flow paths, in which the flow path member includes a pressure chamber substrate that is provided with a pressure chamber which is a portion of the individual flow path and in which pressure is applied to the liquid to eject the liquid, and a communication plate that is provided with a flow path which is a portion of the individual flow path and causes the nozzle and the pressure chamber to communicate with each other, and that has a second surface which is a surface in a second direction that is a direction opposite to the first direction, the pressure chamber substrate is stacked on the second surface, a flow path section located in the second direction with respect to the second surface is disposed with a gap in a third direction which is a direction orthogonal to the first direction and the second direction of the pressure chamber substrate, the communication plate has a plurality of first recessed portions which are recessed from a first surface that is a surface in the first direction of the communication plate to a bottom surface located between the first surface and the second surface, and some of which overlap the gap when viewed in the first direction, and a space defined by the first recessed portion is a portion of the individual flow path. Accordingly, by providing the first recessed portion as a portion of the individual flow path in the communication plate, the rigidity of the communication plate can be improved, and the deformation and cracking of the communication plate when an external force such as a collision with the medium is applied to the surface of the communication plate facing the first direction of the liquid ejecting head can be suppressed.
In Aspect 2 which is a specific example of Aspect 1, the communication plate includes a first through-hole and a second through-hole that penetrate from the first surface to the second surface, a wall portion that is a portion disposed between the first through-hole and the second through-hole, and that is a portion disposed between the second surface and the same plane as the bottom surface, and a plurality of partition walls that are disposed in the first direction with respect to the wall portion, and that separate the plurality of first recessed portions adjacent to each other, a portion of the common flow path is defined by the first through-hole, and a portion of the individual flow path is defined by the second through-hole, and the first recessed portion couples the first through-hole and the second through-hole.
In Aspect 3 which is a specific example of Aspect 2, the plurality of first recessed portions are arranged in a fourth direction intersecting the first direction and the third direction, and a width in the fourth direction of the first recessed portion is larger than a width in the fourth direction of the partition wall. Accordingly, by reducing the width of the partition wall and increasing the width of the first recessed portion which is a portion of the individual flow path, a pressure loss of the liquid due to the narrowing of the width of the individual flow path can be reduced. Even though the width of the partition wall is small, the influence of a decrease in the rigidity of the wall portion is small because there are a plurality of partition walls.
In Aspect 4 which is a specific example of Aspect 2, a width of the partition wall in a fourth direction intersecting the first direction and the third direction is reduced toward the first through-hole. Accordingly, the first recessed portion is formed in the wall portion facing the gap as a portion of the individual flow path in the communication plate, so that the flow path cross-sectional area becomes smaller compared to a configuration in which a portion of the individual flow path is not provided. Therefore, the liquid does not easily flow from the supply common flow path into each first recessed portion. However, the width of the partition wall is reduced toward the first through-hole. In other words, the width in the fourth direction of the first recessed portion becomes wider toward the supply common flow path, and the cross-sectional area of the first recessed portion is increased. Therefore, the liquid easily flows into the first recessed portion. Similarly, the air bubble discharge performance from the supply common flow path to the supply individual flow path can be improved. In addition, a pressure loss of the liquid can be reduced.
In Aspect 5 which is a specific example of Aspect 2, the liquid ejecting head further includes: a flexible member having flexibility, which is stacked in the first direction of the communication plate and defines the plurality of first recessed portions, the first through-hole, and the second through-hole; and a support body that is stacked in the first direction of the flexible member and fixes the flexible member, in which the support body is disposed in the first direction of the first recessed portion. Accordingly, the deformation of a portion of the flexible member defining the first recessed portion can be suppressed by the support body, so that a portion of the individual flow path configured by the first recessed portion can be suppressed from being blocked by the flexible member. Further, the support body is disposed with the flexible member interposed in the first direction of the first recessed portion, so that the rigidity of the individual flow path is increased. In addition, the support body is not disposed in the first direction of the first through-hole. Therefore, the flexible member is deformable in the first through-hole. In this way, a pressure fluctuation of the liquid can be absorbed in the first through-hole.
In Aspect 6 which is a specific example of Aspect 2, the first through-hole has a second portion that is coupled to the flow path provided in the flow path section, and a first portion that is coupled to the second portion and is blocked by a surface in the first direction of the flow path section. Accordingly, a pressure loss of the liquid in the first recessed portion can be reduced. In addition, the flexible member can be deformed not only in the second portion but also in the first portion, and the absorption of a pressure fluctuation of the liquid in the first through-hole can be increased.
In Aspect 7 which is a specific example of Aspect 1, the communication plate and the flow path section are made of an integral member.
In Aspect 8 which is a specific example of Aspect 1, the communication plate has a plurality of second recessed portions which are recessed from the first surface to the bottom surface located between the first surface and the second surface, and some of which overlap the gap when viewed in the first direction, the plurality of individual flow paths include a supply individual flow path for supplying a liquid to the nozzle, and a recovery individual flow path for recovering the liquid not ejected from the nozzle, the common flow path includes a supply common flow path communicating with the plurality of supply individual flow paths, and a recovery common flow path communicating with the plurality of recovery individual flow paths, and one of the space defined by the first recessed portion and a space defined by the second recessed portion is the supply individual flow path, and the other is the recovery individual flow path.
In Aspect 9 which is a specific example of Aspect 1, a width in the first direction from the second surface to the bottom surface is smaller than a width in the first direction of the pressure chamber substrate.
In Aspect 10 which is a specific example of Aspect 1, the flow path member includes a nozzle plate provided with the plurality of nozzles, and a width in the first direction from the second surface to the bottom surface is smaller than a width in the first direction of the nozzle plate.
In Aspect 11 which is a specific example of Aspect 1, a width in the first direction from the second surface to the bottom surface is equal to or less than a width in the first direction of the first recessed portion. Accordingly, by making the width of the first wall portion equal to or less than the width of the first recessed portion, the width in the first direction of the first recessed portion is increased, and the pressure loss can be reduced.
In Aspect 12 which is a specific example of Aspect 1, a width in the first direction from the second surface to the bottom surface is 150 μm or less.
A liquid ejecting apparatus according to Aspect 13, which is an aspect of the liquid ejecting apparatus, includes the liquid ejecting head according to any one of Aspects 1 to 12; and a liquid storage section that supplies a liquid to the liquid ejecting head. Accordingly, a liquid ejecting apparatus can be provided in which the rigidity of a communication plate can be improved and the deformation and cracking of the communication plate when an external force such as a collision with a medium is applied to the surface of a liquid ejecting head facing a first direction can be suppressed.

What is claimed is:

1. A liquid ejecting head comprising:
a flow path member having a plurality of nozzles that eject a liquid in a first direction, a plurality of individual flow paths that individually communicate with the plurality of nozzles, and a common flow path that commonly communicates with the plurality of individual flow paths, wherein
the flow path member includes
a pressure chamber substrate that is provided with a pressure chamber which is a portion of the individual flow path and in which pressure is applied to the liquid to eject the liquid, and
a communication plate that is provided with a flow path which is a portion of the individual flow path and causes the nozzle and the pressure chamber to communicate with each other, and that has a second surface which is a surface in a second direction that is a direction opposite to the first direction,
the pressure chamber substrate is stacked on the second surface,
a flow path section located in the second direction with respect to the second surface is disposed with a gap in a third direction which is a direction orthogonal to the first direction of the pressure chamber substrate,
the communication plate has a plurality of first recessed portions which are recessed from a first surface that is a surface in the first direction of the communication plate to a bottom surface located between the first surface and the second surface, and some of which overlap the gap when viewed in the first direction, and
a space defined by the first recessed portion is a portion of the individual flow path.

2. The liquid ejecting head according to claim 1, wherein
the communication plate includes
a first through-hole and a second through-hole that penetrate from the first surface to the second surface,
a wall portion that is a portion disposed between the first through-hole and the second through-hole, and that is a portion disposed between the second surface and the same plane as the bottom surface, and
a plurality of partition walls that are disposed in the first direction with respect to the wall portion, and that separate the plurality of first recessed portions adjacent to each other,
a portion of the common flow path is defined by the first through-hole, and a portion of the individual flow path is defined by the second through-hole, and
the first recessed portion couples the first through-hole and the second through-hole.

3. The liquid ejecting head according to claim 2, wherein
the plurality of first recessed portions are arranged in a fourth direction intersecting the first direction and the third direction, and
a width in the fourth direction of the first recessed portion is larger than a width in the fourth direction of the partition wall.

4. The liquid ejecting head according to claim 2, wherein
a width of the partition wall in a fourth direction intersecting the first direction and the third direction is reduced toward the first through-hole.

5. The liquid ejecting head according to claim 2, further comprising:
a flexible member having flexibility, which is stacked in the first direction of the communication plate and defines the plurality of first recessed portions, the first through-hole, and the second through-hole; and
a support body that is stacked in the first direction of the flexible member and fixes the flexible member, wherein
the support body is disposed in the first direction of the first recessed portion.

6. The liquid ejecting head according to claim 2, wherein
the first through-hole has
a second portion that is coupled to the flow path provided in the flow path section, and
a first portion that is coupled to the second portion and is blocked by a surface in the first direction of the flow path section.

7. The liquid ejecting head according to claim 1, wherein
the communication plate and the flow path section are made of an integral member.

8. The liquid ejecting head according to claim 1, wherein
the communication plate has a plurality of second recessed portions which are recessed from the first surface to the bottom surface located between the first surface and the second surface, and some of which overlap the gap when viewed in the first direction,
the plurality of individual flow paths include a supply individual flow path for supplying a liquid to the nozzle, and a recovery individual flow path for recovering the liquid not ejected from the nozzle,
the common flow path includes a supply common flow path communicating with the plurality of supply individual flow paths, and a recovery common flow path communicating with the plurality of recovery individual flow paths, and
one of the space defined by the first recessed portion and a space defined by the second recessed portion is the supply individual flow path, and the other is the recovery individual flow path.

9. The liquid ejecting head according to claim 1, wherein
a width in the first direction from the second surface to the bottom surface is smaller than a width in the first direction of the pressure chamber substrate.

10. The liquid ejecting head according to claim 1, wherein
the flow path member includes a nozzle plate provided with the plurality of nozzles, and
a width in the first direction from the second surface to the bottom surface is smaller than a width in the first direction of the nozzle plate.

11. The liquid ejecting head according to claim 1, wherein
a width in the first direction from the second surface to the bottom surface is equal to or less than a width in the first direction of the first recessed portion.

12. The liquid ejecting head according to claim 1, wherein
a width in the first direction from the second surface to the bottom surface is 150 μm or less.

13. A liquid ejecting apparatus comprising:
the liquid ejecting head according to claim 1; and
a liquid storage section that supplies a liquid to the liquid ejecting head.
